(19) United States
(12) Patent Application Publication
(10) Pub. No.: US 2026/0359052 A1
(43) Pub. Date: Nov. 12, 2026

(54) PROCESSOR CORE FOR DEALING WITH COMPUTATION OF FUSED INSTRUCTIONS AND RELATED INSTRUCTION EXECUTION METHOD

(71) Applicant: Airoha Technology Corp., Hsinchu City (TW)

(72) Inventor: Chia-Yu Yeh, Hsinchu County (TW)

(73) Assignee: Airoha Technology Corp., Hsinchu City (TW)

(21) Appl. No.: 19/203,221

(22) Filed: May 9, 2025

(51) Int. Cl. G06F 9/30; G06F 9/38

(52) U.S. Cl. CPC G06F 9/30181; G06F 9/3814; G06F 9/3836

(57) ABSTRACT

A processor core includes a function unit and a fusion controller circuit. The function unit completes computation of each instruction in K batches, wherein an operand of each instruction has a length of N, the function unit completes each batch of the computation of each instruction per clock cycle, and a partial operand with a length of Mis processed in each batch of the computation of each instruction, where K=N/M. The fusion controller circuit fused receives instructions, and controls the function unit to deal with computation of the fused instructions in a time-division multiplexing fashion.

### BACKGROUND OF THE INVENTION

### 1. Field of the Invention

The present invention relates to a processor design, and more particularly, to a processor core for dealing with computation of fused instructions and a related instruction execution method.

### 2. Description of the Prior Art

Most typical processors are equipped with an arithmetic unit which can communicate with a storage device. To perform a given arithmetic function, each of the operands must be successively brought to the arithmetic unit from the storage device, the arithmetic function must be performed, and the result must be returned to the storage device. This process typically takes a great deal of time due to several clock cycles required for transmission between the storage device and the arithmetic unit, plus several clock cycles for performing the operation. There is a need for an innovative processor design which can effectively reduce the number of times of retrieving operands from the storage device and/or the number of times of returning computation results to the storage device.

### SUMMARY OF THE INVENTION

One of the objectives of the claimed invention is to provide a processor core for dealing with computation of fused instructions and a related instruction execution method.

According to a first aspect of the present invention, an exemplary processor core is disclosed. The exemplary processor core includes a function unit and a fusion controller circuit. The function unit is arranged to complete computation of each instruction in K batches, wherein an operand of said each instruction has a length of N, the function unit completes each batch of the computation of said each instruction per clock cycle, and a partial operand with a length of M is processed in said each batch of the computation of said each instruction, where K=N/M. The fusion controller circuit is arranged to receive fused instructions, and control the function unit to deal with computation of the fused instructions in a time-division multiplexing fashion.

According to a second aspect of the present invention, an exemplary processor core is disclosed. The exemplary processor core includes a fusion controller circuit and an instruction decoder circuit. The fusion controller circuit is arranged to receive fused instructions, and control scheduling of computation of the fused instructions. The instruction decoder circuit is arranged to receive a fusion instruction followed by consecutive instructions, where the fusion instruction explicitly indicates that the consecutive instructions are instructions to be fused; and further arranged to transfer the consecutive instructions to the fusion controller circuit as the fused instructions in response to the fusion instruction.

According to a third aspect of the present invention, an exemplary instruction execution method is disclosed. The exemplary instruction execution method includes: receiving fused instructions; and controlling a function unit to deal with computation of the fused instructions in a time-division multiplexing fashion, wherein the function unit is arranged to complete computation of each instruction in K batches, wherein an operand of said each instruction has a length of N, the function unit completes each batch of the computation of said each instruction per clock cycle, and a partial operand with a length of M is processed in said each batch of the computation of said each instruction, where K=N/M.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a vector processor according to an embodiment of the present invention.

FIG. 2 is a diagram illustrating a fusion controller circuit and a function unit according to an embodiment of the present invention.

FIG. 3 is a flowchart illustrating a re-scheduled computation flow of fused instructions according to an embodiment of the present invention.

FIG. 4 is a diagram illustrating a computation schedule of fused vector instructions that is determined by a fusion controller circuit according to an embodiment of the present invention.

FIG. 5 is a diagram illustrating an operand fetch sequence for computation of fused vector MAC instructions with vector chaining according to an embodiment of the present invention.

FIG. 6 is a diagram illustrating a computation result write-back sequence for computation of fused vector MAC instructions with vector chaining according to an embodiment of the present invention.

FIG. 7 is a diagram illustrating an operand fetch sequence for computation of fused vector MUL instructions with vector sharing according to an embodiment of the present invention.

FIG. 8 is a diagram illustrating a computation result write-back sequence for computation of fused vector MUL instructions with vector sharing according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

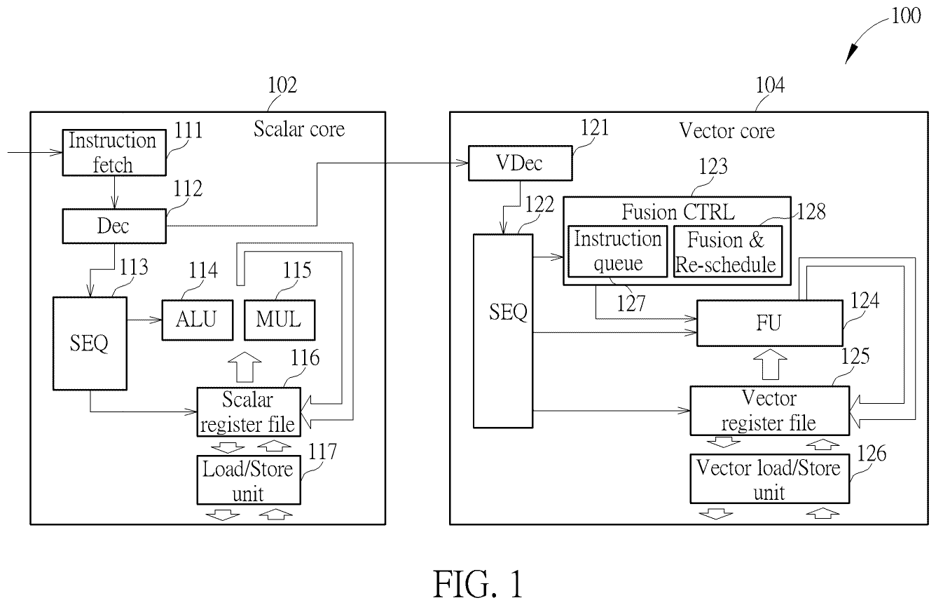

FIG. 1 is a diagram illustrating a vector processor according to an embodiment of the present invention. The vector processor 100 may have a plurality of processor cores, including a scalar core 102 and a vector core 104. The scalar core 102 is arranged to set up instructions so that the vector core 104 can operate. For example, the scalar core 102 may distribute program control, conditional branches, functional calls, etc. The scalar core 102 may include an instruction fetch circuit (labeled by “instruction fetch”) 111, an instruction decoder circuit (labeled by “Dec”) 112, a sequencer (labeled by “SEQ”) 113, an arithmetic logic unit (labeled by “ALU”) 114, a multiplier (labeled by “MUL”) 115, a scalar register file (which consists of a plurality of registers) 116, and a load/store unit 117. Since the present invention is focused on the design of the vector core 104 and the scalar core 102 can be implemented using any conventional design, further description of the scalar core 102 is omitted here for brevity.

The vector core 104 supports computation of normal vector instructions without vector chaining and vector sharing and computation of fused vector instructions with vector chaining and/or vector sharing. The vector chaining allows a vector operation to start as soon as the individual elements of its vector source operand become available. The vector sharing allows elements of the same vector source operand to be shared between different vector operations. As shown in FIG. 1, the vector core 104 may include a vector instruction decoder circuit (labeled by “VDec”) 121, a sequencer (labeled by “SEQ”) 122, a fusion controller circuit (labeled by “Fusion CTRL”) 123, a function unit (labeled by “FU”) 124, a vector register file (which consists of a plurality of registers) 125, and a vector load/store unit 126. The fusion controller circuit 123 may include an instruction queue 127 and a fusion and re-scheduling circuit (labeled by “fusion & re-schedule”) 128. The instruction queue 127 is arranged to store vector instructions to be processed by the function unit 124. The maximum number of vector instructions that can be fused depends on the size of the instruction queue 127. The fusion and re-scheduling circuit 128 is arranged to re-schedule computation of vector instructions stored in the instruction queue 127.

In this embodiment, since the function unit 124 is employed by the vector core 104 of the vector processor 100, the function unit 124 is arranged to complete computation of each instruction (e.g., a vector instruction) in K batches, wherein an operand (e.g., a vector that is a linear array of numbers) of each instruction has a length of N, the function unit 124 completes each batch of the computation of each instruction per clock cycle, and a partial operand with a length of M (e.g., a partial vector with M elements) is processed in each batch of the computation of each instruction, where

$$K = \frac{N}{M} .$$

In this embodiment of the present invention, the function unit 124 supports different arithmetic operations (e.g., add/subtract, multiply, divide, accumulate, logic operation), and can be shared between different instructions that are fused instructions. That is, the function unit 124 may be used for dealing with computation of one instruction included in a sequence of fused instructions, and can be re-used for dealing with computation of another instruction included in the sequence of fused instructions. To achieve the objective of sharing the same function unit 124 between fused instructions, the fusion controller circuit 123 is arranged to receive the fused instructions, and control the function unit 124 to deal with computation of the fused instructions in a time-division multiplexing fashion. In the following description, the terms “instruction” and “vector instruction” may be interchangeable.

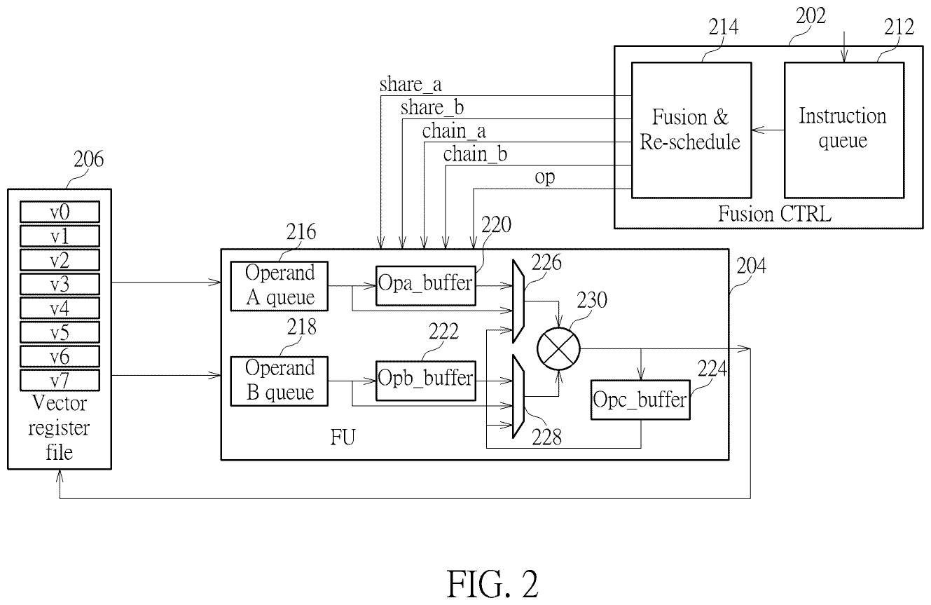

FIG. 2 is a diagram illustrating a fusion controller circuit and a function unit according to an embodiment of the present invention. The fusion controller circuit 123 shown in FIG. 1 may be implemented using the fusion controller circuit 202 shown in FIG. 2, the function unit 124 shown in FIG. 1 may be implemented using the function unit 204 shown in FIG. 2, and the vector register file 125 shown in FIG. 1 may be implemented using the vector register file 206 shown in FIG. 2. The vector register file 206 includes a plurality of registers such as v0, v1, . . . , v7. The instruction queue 212 is arranged to buffer consecutive instructions that are treated as instructions to be fused. In some embodiments of the present invention, the instruction decoder circuit 121 of the vector core 104 is arranged to receive a fusion instruction (e.g., vsigma) followed by consecutive instructions to be fused, where the fusion instruction (e.g., vsigma) explicitly indicates that the following consecutive instructions are instructions to be fused; and the instruction decoder circuit 121 is further arranged to transfer the consecutive instructions to the fusion controller circuit 123/202 as the fused instructions in response to the fusion instruction (e.g., vsigma).

The explicit fusion instruction may specify the number of instructions to be fused, and may specify which instructions are to be fused. Since the instructions to be fused are programmer-defined and explicitly indicated by the fusion instruction (e.g., vsigma) inserted into the program code, drawbacks of the conventional design that performs on-line detection of instructions to be fused by the processor can be avoided. For example, the conventional design that uses the processor to perform on-line detection of instructions to be fused takes several clock cycles to detect existence of instructions that can be fused, which results in latency of the instruction execution. Compared to the conventional vector processor design, the proposed vector processor design uses a particular fusion instruction (e.g., vsigma) in the program code to explicitly indicate which instructions are to be fused. In this way, the computation efficiency of fused instructions can be greatly improved by taking the advantage of the explicit fusion instruction. For another example, the conventional design that uses the processor to perform on-line detection of instructions to be fused may fail to make the best decision on which instructions are to be fused, which results in degraded performance of the vector processor. Compared to the conventional vector processor design, the proposed vector processor design uses the programmer-defined fusion instruction (e.g., vsigma) in the program code to explicitly indicate which instructions are to be fused. In this way, the computation efficiency of fused instructions can be greatly improved due to the fusion instruction correctly inserted into the program code by the programmer who has the best knowledge of vector chaining relationship and/or vector sharing relationship among instructions.

The fusion and re-scheduling circuit 214 is arranged to re-schedule computation of consecutive instructions to be fused, thereby enabling the function unit 204 to deal with computation of fused instructions in a time-division multiplexing fashion. For example, the fusion and re-scheduling circuit 214 may generate a plurality of control signals share_a, share_b, chain_a, chain_b, op to the function unit 204. As shown in FIG. 2, the function unit 204 may include a plurality of operand queues (labeled by “operand A queue” and “operand B queue”) 216, 218, a plurality of internal buffers (labeled by “Opa_buffer”, “Opb_buffer”, “Opc_buffer”) 220, 222, 224, a plurality of multiplexers 226, 228, and a programmable vector computation circuit 230. It should be noted that the number of operand queues, the number of internal buffers, and the number of multiplexers may be adjusted, depending upon actual design considerations.

Regarding each of fused instructions, an operand A (e.g., a first partial vector A with M elements) is loaded from one of registers v0-v7 included in the vector register file 206 and stored into the operand queue 216, and an operand B (e.g., a second partial vector B with M elements) is loaded from another of registers v0-v7 included in the vector register file 206 and stored into the operand queue 218. The operand A/B can be an input data of one of fused instructions, and can be stored into the internal buffer 220/222 to be later loaded as an input data of another of fused instructions by taking the advantage of the vector sharing relationship between fused instructions. With the help of the internal buffer 220/222, loading an operand (e.g., partial vector with M elements) from the vector register file 206 external to the function unit 204 can be omitted, and the required operand (e.g., partial vector with M elements) can be loaded from the internal buffer 220/222 of the function unit 204. In this way, the computation efficiency of fused instructions can be improved.

Furthermore, a computation result of one of fused instructions can be stored into the internal buffer 224, and can be later loaded as an input data of another fused instruction by taking the advantage of the vector chaining relationship between fused instructions. With the help of the internal buffer 224, loading an operand (e.g., computation result of a previous instruction) from the vector register file 206 external to the function unit 204 can be omitted, and the required operand (e.g., computation result of a previous instruction) can be loaded from the internal buffer 224 of the function unit 204. In this way, the computation efficiency of fused instructions can be improved. In addition, a computation result generated from the programmable vector computation circuit 230 may be stored into the internal buffer 224, and storing the computation result into one of the registers v0-v7 included in the vector register file 206 may be omitted.

The multiplexer 226 may be controlled by the control signal share_a/chain_a, where the control signal share_a may control behavior of the multiplexer 226 during computation of fused instructions with vector sharing relationship, and the control signal chain_a may control behavior of the multiplexer 226 during computation of fused instructions with vector chaining relationship. The multiplexer 228 may be controlled by the control signal share_b/chain_b, where the control signal share_b may control behavior of the multiplexer 228 during computation of fused instructions with vector sharing relationship, and the control signal chain_b may control behavior of the multiplexer 228 during computation of fused instructions with vector chaining relationship. The programmable vector computation circuit 230 may be controlled by the control signal op, where the control signal op may specify a requested arithmetic operation (e.g., add/subtract, multiply, divide, accumulate, or logic operation) during computation of fused instructions with vector chaining relationship or vector sharing relationship.

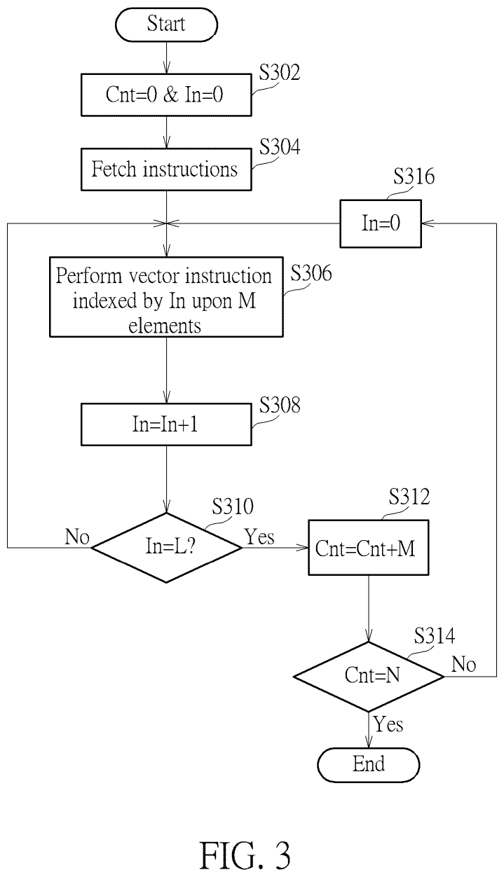

As mentioned above, the fusion and re-scheduling circuit 214 is arranged to re-schedule computation of consecutive instructions to be fused, such that the function unit 204 follows a computation schedule to deal with computation of fused instructions in a time-division multiplexing fashion. FIG. 3 is a flowchart illustrating a re-scheduled computation flow of fused instructions according to an embodiment of the present invention. It is assumed that the number of instructions to be fused is L, the function unit 124/204 is designed to complete computation of a vector instruction in K

$$( K = \frac{N}{M} )$$

batches, an operand of a vector instruction has a length of N (i.e., a vector length is N), and the function unit 124/204 completes each batch of computation of the vector instruction per clock cycle, where a partial operand with a length of M (i.e., a partial vector with M elements) is processed in each batch of computation of the vector instruction. At step S302, two control parameters Cnt and In are initialized, where the control parameter Cnt indicates the number of elements already processed by the function unit 124/204, and the control parameter In indicates an index of a current vector instruction (i.e., the n^{th} vector instruction, where 0≤n≤(L−1)) to be processed by the function unit 124/204. For example, each of the control parameters Cnt and In may be set by an initial value “0”. At step S304, fused instructions are fetched and stored into the instruction queue 127/212 of the fusion controller circuit 123/202. At step 306, the function unit 124/204 performs a fused vector instruction indexed by the control parameter In upon M elements. At step S308, the control parameter In is updated (e.g., In=In+1). At step S310, it is checked to see if the control parameter In reaches L. If the control parameter In does not reach L yet, the function unit 124/204 performs a next fused vector instruction indexed by the updated control parameter In upon M elements (step S306). If the control parameter In reaches L, meaning that computation of the n^{th} (0≤n≤(K−1)) batches of L fused vector instructions is completed, the flow proceeds with step S312 to update the control parameter Cnt (e.g., Cnt=Cnt+M). At step S314, it is checked to see if the control parameter Cnt reaches N. If the control parameter Cnt does not reach N yet, meaning that computation of last batches (i.e., the (K−1)^{th} batches) of L fused vector instructions is not completed yet, the flow proceeds with step S316 to reset the control parameter In to the initial value “0”, and then the function unit 124/204 performs a fused vector instruction indexed by the initialized control parameter In upon next M elements (step S306). If the control parameter Cnt reaches N, meaning that computation of last batches (i.e., (K−1)^{th} batches) of L fused vector instructions is completed, the function unit 124/204 ends computation of L fused vector instructions.

For better comprehension of technical features of the present invention, several instruction execution examples are provided as below.

In a first instruction fusion example, there are 4 consecutive vector multiply-accumulate (MAC) instructions i0, i1, i2, i3, and a fusion instruction i−1 preceding the vector MAC instruction i0 (which is a starting instruction of consecutive vector MAC instructions i0, i1, i2, i3) explicitly indicates that the following 4 instructions (i.e., vector MAC instructions i0, i1, i2, i3) are instructions to be fused.
i−1: vsigma 4
i0: vzwmac.vv v24, v12, v0
i1: Vzwmac.vv v24, v13, v1
i2: vzwmac.vv v24, v14, v2
i3: vzwmac.vv v24, v15, v3

The vector MAC instructions i0, i1, i2, i3 are used for performing the following mathematic equation:

$${\sum }_{i = 0}^{N - 1} {V}_{a} ( i ) * {V}_{b} ( i ) + {\sum }_{i = 0}^{N - 1} {V}_{c} ( i ) * {V}_{d} ( i ) + {\sum }_{i = 0}^{N - 1} {V}_{e} ( i ) * {V}_{f} ( i ) + {\sum }_{i = 0}^{N - 1} {V}_{g} ( i ) * {V}_{h} ( i ) ,$$

where i0 is used for performing

$${\sum }_{i = 0}^{N - 1} [ {V}_{a} ( i ) * {V}_{b} ( i ) ]$$

with Operand A loaded into Vₐ (i) and Operand B loaded into V_{b} (i); i1 is used for performing

$${\sum }_{i = 0}^{N - 1} [ {V}_{c} ( i ) * {V}_{d} ( i ) ]$$

with Operand A loaded into V_{c} (i) and Operand B loaded into V_{d} (i); i2 is used for performing

$${\sum }_{i = 0}^{N - 1} [ {V}_{e} ( i ) * {V}_{f} ( i ) ]$$

with Operand A loaded into Vₑ (i) and Operand B loaded into V_{f}(i); and i3 is used for performing

$${\sum }_{i = 0}^{N - 1} [ {V}_{g} ( i ) * {V}_{h} ( i ) ]$$

with Operand A loaded into V_{g} (i) and Operand B loaded into Vₕ (i).

The vector MAC instructions i0, i1, i2, i3 share the same register v24 which is an accumulator acting as both an operand and a computation result. Hence, there is chaining relationship between i0 and i1, i1 and i2, and i2 and i3. In this embodiment, the number of instructions to be fused is 4 (L=4), and the function unit 124/204 is designed to complete computation of one vector MAC instruction in 4

$$( K = \frac{N}{M} = 4 )$$

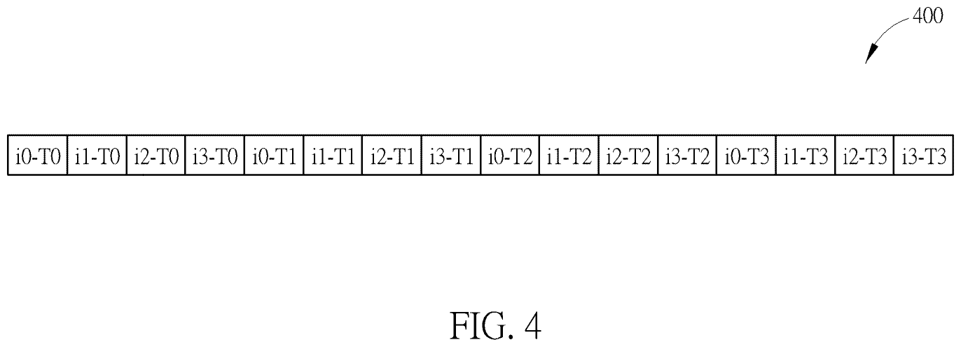

batches. FIG. 4 is a diagram illustrating a computation schedule of fused vector instructions (e.g., vector MAC instructions i0, i1, i2, i3) that is determined by the fusion controller circuit 123/202 according to an embodiment of the present invention. Regarding the computation schedule 400, “in” represents the n^{th} instruction, and “In” represents the n^{th} batch of computation of one instruction, where 0≤n≤3. As shown in FIG. 4, the function unit 124/204 sequentially completes the n^{th} batch of computation of the vector instruction i0, the n^{th} batch of computation of the vector instruction i1, the n^{th} batch of computation of the vector instruction 12, and the n^{th} batch of computation of the vector instruction i3, where 0≤n≤3. In other words, the function unit 124/204 does not start an (n+1)th batch of computation of the vector instruction i0 (which is a starting instruction of fused instructions) before an n^{th} batch of computation of the vector instruction i3 (which is a last instruction of fused instructions) is completed, where 0≤n≤2. Specifically, the function unit 124/204 does not start an (n+1)th batch of computation of any of the vector instructions i0, i1, i2, i3 before n^{th} batches of computation of all vector instructions i0-i3 are completed, where 0≤n≤2. In this example, the computation flow is re-scheduled to take the advantage of the chaining relationship between fused vector instructions.

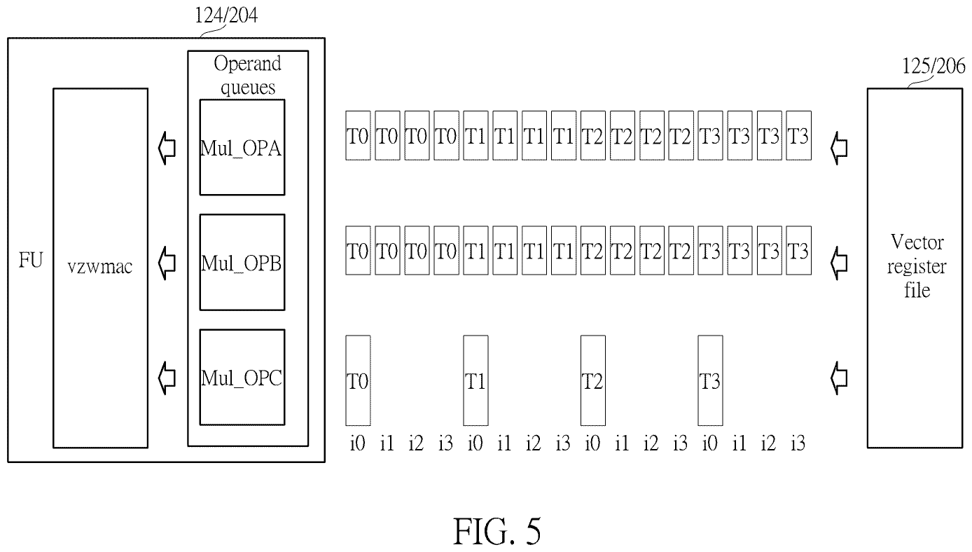

FIG. 5 is a diagram illustrating an operand fetch sequence for computation of vector MAC instructions i0, i1, i2, i3 with vector chaining according to an embodiment of the present invention. Regarding computation of the 0^{th} batch T0 of the 0^{th} vector MAC instruction i0 (which is starting instruction of fused instructions), an operand A (which is a partial vector with M elements) is loaded from a register v0, an operand B (which is a partial vector with M elements) is loaded from a register v12, an operand C is loaded from a register v24, and an MAC computation result is stored into the internal buffer 224. Regarding computation of the 0th batch TO of the 1th vector MAC instruction i1, an operand A (which is a partial vector with M elements) is loaded from a register v1, an operand B (which is a partial vector with M elements) is loaded from a register v13, and an operand C is loaded from the internal buffer 224 by taking the advantage of vector chaining. Regarding computation of the 0^{th} batch T0 of the 2^{nd} vector MAC instruction i2, an operand A (which is a partial vector with M elements) is loaded from a register v2, an operand B (which is a partial vector with M elements) is loaded from a register v14, and an operand C is loaded from the internal buffer 224 by taking the advantage of vector chaining. Regarding computation of the 0^{th} batch T0 of the 3^{rd} vector MAC instruction i3 (which is a last instruction of fused instructions), an operand A (which is a partial vector with M elements) is loaded from a register v3, an operand B (which is a partial vector with M elements) is loaded from a register v14, and an operand C is loaded from the internal buffer 224 by taking the advantage of vector chaining.

Since a person skilled in the art can readily understand details of computation of remaining 1^{st}, 2^{nd}, and 3^{rd} batches of vector MAC instructions i0, i1, i2, i3 after reading above paragraph directed to computation of 0^{th} batches of vector MAC instructions i0, i1, i2, i3, similar description is not repeated here for brevity.

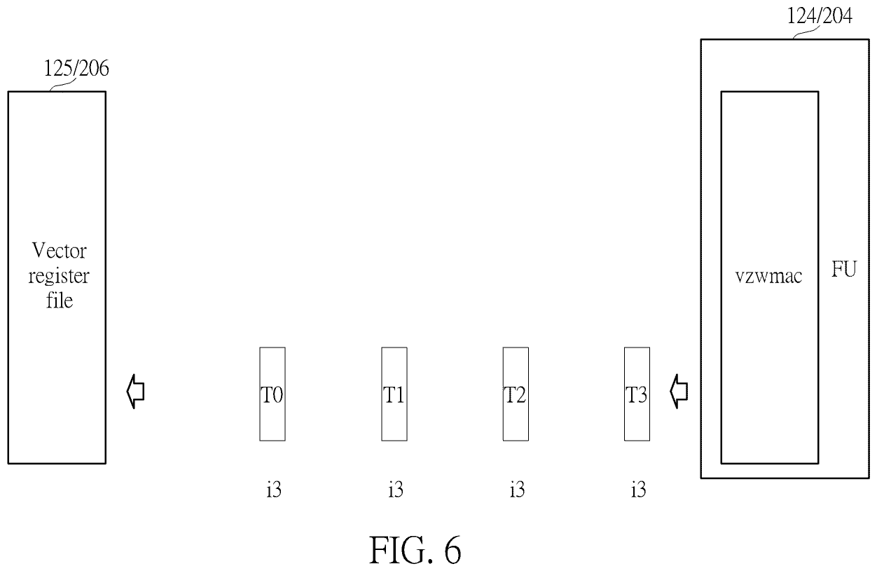

FIG. 6 is a diagram illustrating a computation result write-back sequence for computation of vector MAC instructions i0, i1, i2, i3 with vector chaining according to an embodiment of the present invention. When computation of the 0^{th} batch T0 of the 3^{rd} vector MAC instruction i3 (which is a last instruction of fused instructions) is completed, the function unit 124/204 stores a MAC computation result of the 0^{th} batch T0 of the 3^{rd} vector MAC instruction 13 into the register V24. When computation of the 1^{th} batch T1 of the 3^{rd} vector MAC instruction i3 (which is a last instruction of fused instructions) is completed, the function unit 124/204 stores a MAC computation result of the 1^{th} batch T0 of the 3^{rd} vector MAC instruction i3 into the register V24. When computation of the 2^{nd} batch T2 of the 3^{rd} vector MAC instruction i3 (which is a last instruction of fused instructions) is completed, the function unit 124/204 stores a MAC computation result of the 2^{nd} batch T2 of the 3^{rd} vector MAC instruction i3 into the register V24. When computation of the 3^{rd} batch T3 of the 3^{rd} vector MAC instruction i3 (which is a last instruction of fused instructions) is completed, the function unit 124/204 stores a MAC computation result of the 3^{rd} batch T3 of the 3^{rd} vector MAC instruction i3 into the register V24.

As shown in FIG. 5, the operand data bandwidth requirement for the operand A is 4*4=16 (i.e., L=4 and K=4), the operand data bandwidth requirement for the operand Bis 4*4=16 (i.e., L=4 and K=4), and the operand data bandwidth requirement for the operand C (which is an accumulation result of A*B, and has a bit width twice that of the operand A/B) is 4*2=8 (i.e., K=4 and bit width=2), wherein such operand data bandwidth requirement results from load of an Operand C from the register v24 only for the first instruction i0, and for the subsequent instructions i1, i2, and i3, no operand data bandwidth costs for an Operand C because an Operand C is loaded from the internal buffer 224 instead of the register v24. Regarding the conventional vector processor design without using the proposed internal buffer to buffer a computation result, the operand data bandwidth requirement for the operand A is 4*4=16, the operand data bandwidth requirement for the operand B is 4*4=16, and the operand data bandwidth requirement for the operand C is 4*4*2=32 (i.e., L=4, K=4 and bit width=2). Hence, the vector processor design using the proposed internal buffer to buffer a computation result can reduce the total operand data bandwidth requirement to 37.5% (i.e., (64−40)/64=37.5%), where 40=16+16+8 and 64=16+16+32.

As shown in FIG. 6, the computation result write-back bandwidth requirement is 4*2=8. Regarding the conventional vector processor design without using the proposed internal buffer to buffer a computation result, the computation result write-back bandwidth requirement is 4*4*2=32. Hence, the vector processor design using the proposed internal buffer to buffer a computation result can reduce the total computation result write-back bandwidth requirement to 75% (i.e., (32−8)/32=75%).

In a second instruction fusion example, there are 4 consecutive vector multiply (MUL) instructions i0, i1, i2, i3, and a fusion instruction i-1 preceding the vector MAC instruction i0 (which is a starting instruction of vector MUL instructions i0, i1, i2, i3) explicitly indicates that the following 4 instructions (i.e., vector MUL instructions i0, i1, i2, i3) are instructions to be fused.
i-1: vsigma 4
i0: vzwmul.vv v24, v12, v0
i1: vzwmul.vv v26, v12, v1
i2: vzwmul.vv v28, v12, v2
i3: vzwmul.vv v30, v12, v3

The vector MUL instructions i0, i1, i2, i3 share the same register v12 which acts as an operand. Hence, there is sharing relationship between i0, i1, i2 and i3. In this embodiment, the number of instructions to be fused is 4 (L=4), and the function unit 124/204 is designed to complete computation of one vector MUL instruction in 4

$$( K = \frac{N}{M} = 4 )$$

batches. The same computation schedule shown in FIG. 4 may be determined by the fusion controller circuit 123/202 for computation of the vector MUL instructions i0, i1, i2, i3. The computation flow is re-scheduled to take the advantage of the sharing relationship between fused vector instructions.

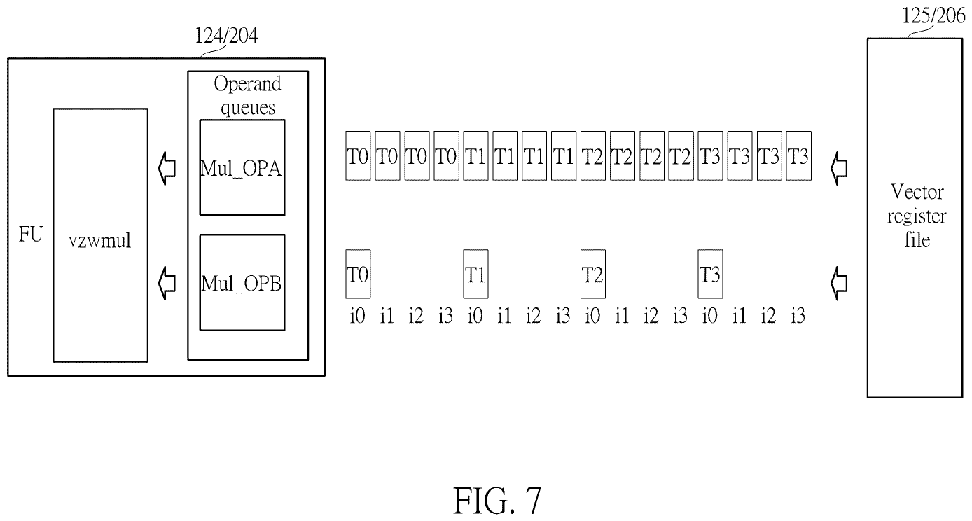

FIG. 7 is a diagram illustrating an operand fetch sequence for computation of vector MUL instructions i0, i1, i2, i3 with vector sharing according to an embodiment of the present invention. Regarding computation of the 0^{th} batch T0 of the 0^{th} vector MUL instruction i0 (which is a starting instruction of fused instructions), an operand A (which is a partial vector with Melements) is loaded from a register v0, and an operand B (which is a partial vector with M elements) is loaded from a register v12 and stored into the internal buffer 222 for later use. Regarding computation of the 0^{th} batch T0 of the 1^{th} vector MUL instruction i1, an operand A (which is a partial vector with M elements) is loaded from a register v1, and the operand B (which is a partial vector with M elements) previously loaded from register v12 and now available in the internal buffer 222 is loaded from the internal buffer 222 as an input data by taking the advantage of vector sharing. Regarding computation of the 0^{th} batch T0 of the 2^{nd} vector MUL instruction i2, an operand A (which is a partial vector with M elements) is loaded from a register v2, and the operand B (which is a partial vector with M elements) previously loaded from register v12 and now available in the internal buffer 222 is loaded from the internal buffer 222 as an input data by taking the advantage of vector sharing. Regarding computation of the 0^{th} batch T0 of the 3^{rd} vector MUL instruction i3, an operand A (which is a partial vector with M elements) is loaded from a register v3, and the operand B (which is a partial vector with M elements) previously loaded from register v12 and now available in the internal buffer 222 is loaded from the internal buffer 222 as an input data by taking the advantage of vector sharing.

Since a person skilled in the art can readily understand details of computation of remaining 1^{st}, 2^{nd}, and 3^{rd} batches of vector MUL instructions i0, i1, i2, i3 after reading above paragraph directed to computation of 0^{th} batches of vector MUL instructions i0, i1, i2, i3, similar description is not repeated here for brevity.

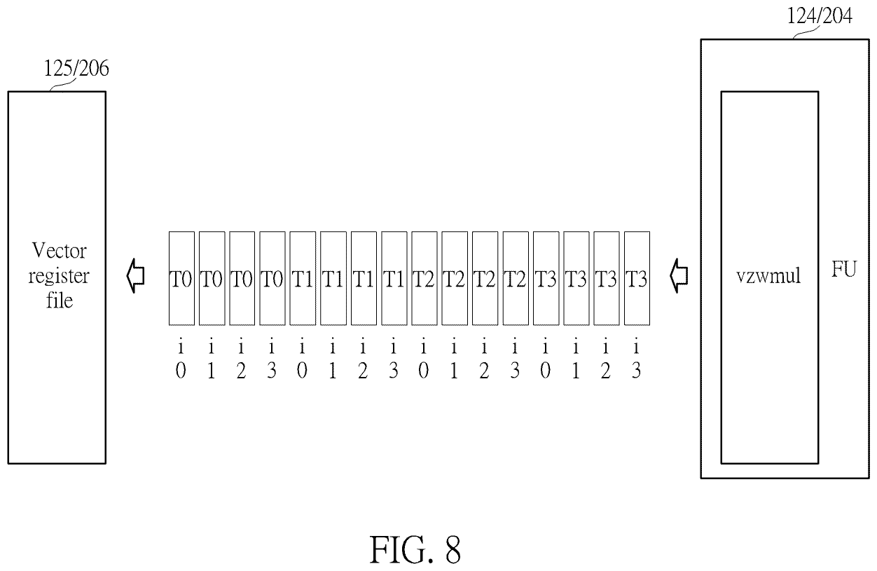

FIG. 8 is a diagram illustrating a computation result write-back sequence for computation of vector MUL instructions i0, i1, i2, i3 with vector sharing according to an embodiment of the present invention. When computation of an n^{th} batch T0 of an m^{th} vector MUL instruction is completed (0≤n≤3 & 0≤m≤3), the function unit 124/204 stores a computation result of the n^{th} batch T0 of the m^{th} vector MUL instruction into a designated register V24/V26/V28/V30.

As shown in FIG. 7, the operand data bandwidth requirement for the operand A is 4*4=16, and the operand data bandwidth requirement for the operand B is 1*4=4. As shown in FIG. 8, the computation result write-back bandwidth requirement is 4*4*2=32, where a multiplication result A*B has a bit width twice that of the operand A/B. Regarding the conventional vector processor design without using the proposed internal buffer to buffer a shared operand, the operand data bandwidth requirement for the operand A is 4*4=16, and the operand data bandwidth requirement for the operand B is 4*4=16. Hence, the vector processor design using the proposed internal buffer to buffer a shared operand can reduce the total operand data bandwidth requirement to 37.5% (i.e., (32−20)/32=37.5%). Regarding the conventional vector processor design without using the proposed internal buffer to buffer a shared V12 operand, the computation result write-back bandwidth requirement is 4*4*2=32. The vector processor design using the proposed internal buffer to buffer a shared operand has the same total computation result write-back bandwidth requirement.

In above embodiments, the proposed fusion controller circuit and function unit are employed by a vector processor (particularly, a vector core of the vector processor). However, this is for illustrative purposes only, and is not meant to be a limitation of the present invention. In practice, the proposed fusion controller circuit and function unit may be employed by a different processor with instruction fusion capability. To put it simply, any processor design using one or both of the feature of sharing the same function unit between different fused instructions and the feature of using a particular fusion instruction to explicitly specify consecutive instructions to be fused falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processor core comprising:
a function unit, arranged to complete computation of each instruction in K batches, wherein an operand of said each instruction has a length of N, the function unit completes each batch of the computation of said each instruction per clock cycle, and a partial operand with a length of M is processed in said each batch of the computation of said each instruction, where K=N/M; and
a fusion controller circuit, arranged to receive fused instructions, and control the function unit to deal with computation of the fused instructions in a time-division multiplexing fashion.

2. The processor core of claim 1, further comprising:
an instruction decoder circuit, arranged to receive a fusion instruction followed by consecutive instructions, where the fusion instruction explicitly indicates that the consecutive instructions are instructions to be fused; and further arranged to transfer the consecutive instructions to the fusion controller circuit as the fused instructions in response to the fusion instruction.

3. The processor core of claim 1, wherein the fused instructions received by the fusion controller circuit comprise consecutive instructions including a first instruction and a second instruction following the first instruction, the fusion controller circuit is further arranged to re-schedule computation of the consecutive instructions, and the function unit sequentially completes an n^{th} batch of computation of the first instruction and an n^{th} batch of computation of the second instruction, where 0≤n≤(K−1).

4. The processor core of claim 3, wherein the function unit comprises an internal buffer, stores a computation result of the n^{th} batch of the computation of the first instruction into the internal buffer, and loads the computation result from the internal buffer as an input data of the n^{th} batch of the computation of the second instruction.

5. The processor core of claim 4, further comprising:
a register file, comprising a plurality of registers;
wherein the second instruction is a last instruction of the consecutive instructions, and the function unit stores a computation result of the n^{th} batch of the computation of the second instruction into one of the plurality of registers.

6. The processor core of claim 3, further comprising:
a register file, comprising a plurality of registers;
wherein the first instruction is a starting instruction of the consecutive instructions, the function unit comprises an internal buffer, loads an input data of the n^{th} batch of the computation of the first instruction from one of the plurality of registers, stores the input data into the internal buffer, and loads the input data from the internal buffer as an input data of the n^{th} batch of the computation of the second instruction.

7. The processor core of claim 1, wherein the fused instructions received by the fusion controller circuit comprise consecutive instructions including a first instruction and a second instruction following the first instruction, the fusion controller circuit is further arranged to re-schedule computation of the consecutive instructions, and the function unit does not start an (n+1)^{th} batch of computation of the first instruction before an n^{th} batch of computation of the second instruction is completed, where 0≤n≤(K−2).

8. The processor core of claim 7, wherein the function unit comprises an internal buffer, stores a computation result of an n^{th} batch of the computation of the first instruction into the internal buffer, and loads the computation result from the internal buffer as an input data of the n^{th} batch of the computation of the second instruction.

9. The processor core of claim 8, further comprising:
a register file, comprising a plurality of registers;
wherein the second instruction is a last instruction of the consecutive instructions, and the function unit stores a computation result of the n^{th} batch of the computation of the second instruction into one of the plurality of registers.

10. The processor core of claim 7, further comprising:
a register file, comprising a plurality of registers;
wherein the first instruction is a starting instruction of the consecutive instructions, the function unit comprises an internal buffer, loads an input data of an n^{th} batch of the computation of the first instruction from one of the plurality of registers, stores the input data into the internal buffer, and loads the input data from the internal buffer as an input data of the n^{th} batch of the computation of the second instruction.

11. The processor core of claim 1, wherein the processor core is a part of a vector processor, and the operand of said each instruction is a vector.

12. A processor core comprising:
a fusion controller circuit, arranged to receive fused instructions, and control scheduling of computation of the fused instructions; and
an instruction decoder circuit, arranged to receive a fusion instruction followed by consecutive instructions, where the fusion instruction explicitly indicates that the consecutive instructions are instructions to be fused; and further arranged to transfer the consecutive instructions to the fusion controller circuit as the fused instructions in response to the fusion instruction.

13. The processor core of claim 12, further comprising:
a function unit, arranged to complete computation of one of the fused instructions in K batches, wherein an operand of said one of the fused instructions has a length of N, the function unit completes each batch of the computation of said one of the fused instructions per clock cycle, and a partial operand with a length of M is processed in said each batch of the computation of said one of the fused instructions, where K=N/M.

14. The processor core of claim 13, wherein the processor core is a part of a vector processor, and the operand of said one of the fused instructions is a vector.

15. An instruction execution method comprising:
receiving fused instructions; and
controlling a function unit to deal with computation of the fused instructions in a time-division multiplexing fashion, wherein the function unit is arranged to complete computation of each instruction in K batches, wherein an operand of said each instruction has a length of N, the function unit completes each batch of the computation of said each instruction per clock cycle, and a partial operand with a length of M is processed in said each batch of the computation of said each instruction, where K=N/M.

16. The instruction execution method of claim 15, further comprising:
performing instruction decoding upon a fusion instruction followed by consecutive instructions, and transferring the consecutive instructions as the fused instructions in response to the fusion instruction, wherein the fusion instruction explicitly indicates that the consecutive instructions are instructions to be fused.

17. The instruction execution method of claim 15, wherein the fused instructions comprise consecutive instructions including a first instruction and a second instruction following the first instruction, and controlling the function unit to deal with the computation of the fused instructions in the time-division multiplexing fashion comprises:
re-scheduling computation of the consecutive instructions; and
controlling the function unit to sequentially complete an n^{th} batch of computation of the first instruction and an n^{th} batch of computation of the second instruction, where 0≤n≤(K−1).

18. The instruction execution method of claim 15, wherein the fused instructions received by the fusion controller circuit comprise consecutive instructions including a first instruction and a second instruction following the first instruction, and controlling the function unit to deal with the computation of the fused instructions in the time-division multiplexing fashion comprises:
re-scheduling computation of the consecutive instructions; and
controlling the function unit not to start an (n+1)^{th} batch of computation of the first instruction before an n^{th} batch of computation of the second instruction is completed, where 0≤n≤(K−2).

19. The instruction execution method of claim 15, wherein the instruction execution method is performed by a vector processor, and the operand of said each instruction is a vector.
